(19) United States
(12) Patent Application Publication
(10) Pub. No.: US 2005/0093286 A1
(43) Pub. Date: May 5, 2005

(54) Suspension mounting structure of vehicle

(76) Inventor: Hee Dae Oh, Suwon-city (KR)

Correspondence Address: MORGAN, LEWIS & BOCKIUS LLP (SF), 2 PALO ALTO SQUARE, PALO ALTO, CA, 94306, US

(21) Appl. No.: 10/886,456

(22) Filed: Jul. 7, 2004

(30) Foreign Application Priority Data
Oct. 29, 2003 (KR) 10-2003-0075879

(51) Int. Cl. B62D 21/11; B60G 15/07

(52) U.S. Cl. 280/788; 280/124.155

(57) ABSTRACT

A suspension mounting structure for a vehicle in which a front mounting rail and a front mounting bracket are installed with weld nuts, and a rear mounting rail and a rear mounting bracket are installed with weld nuts at the bottom of a shock absorber housing panel so that a suspension module whose shock absorber and upper arm have been modularized in one body may be mounted on a car body as a sturdy structure. The appearance of the suspension mounting part viewed from an engine room is thus elegant, and workability of mounting a suspension module is very simple.

### CROSS-REFERENCE TO RELATED APPLICATIONS

This application claims priority of Korean Application No. 10-2003-0075879, filed Oct. 29, 2004, the disclosure of which is incorporated herein by reference.

### FIELD OF THE INVENTION

This invention relates to a suspension mounting structure of a vehicle and more specifically to a suspension module in which a shock absorber and an upper arm are modularized as one body in a car body.

### BACKGROUND OF THE INVENTION

The structure for mounting a suspension in a car body must provide sufficient rigidness to enable stable driving and effectively suppress generation of noise and vibration during driving. On the other hand, while appearance inside the engine room has also recently emerged as an important aspect of a vehicle, appearance around the suspension mounting area seen from an engine room must be finished elegantly as well.

Of course, in addition to sufficient rigidity and esthetic appearance around the suspension mounting area as described above, it is a very important factor how easily the work of mounting a suspension in a car body may be accomplished.

### SUMMARY OF THE INVENTION

Embodiments of the present invention provide a suspension mounting structure of a vehicle, wherein a suspension module that has modularized a shock absorber and an upper arm in one body may be mounted in a car body as a sturdy structure. In a preferred embodiment a structure for suspension mounting of a vehicle comprises a shock absorber housing panel, wherein a front apron member is combined with its top end, and a front side member is combined with its bottom end. A front mounting rail and a rear mounting rail are provided, wherein top ends are combined with the front apron member and bottom ends combined with the front side member at the bottom side of the shock absorber housing panel, before being deployed respectively in the front and rear direction of a vehicle so that a closed cross section may be formed with the shock absorber housing panel. A front mounting bracket is installed between the front mounting rail and shock absorber housing panel so that weld nuts may be fixed with the front mounting rail. A rear mounting bracket is installed between the rear mounting rail and shock absorber housing panel so that weld nuts may be fixed with the rear mounting rail.

### BRIEF DESCRIPTION OF THE DRAWINGS

FIG. 1 is a perspective view from the top of a vehicle that illustrates a suspension mounting structure of a vehicle according to this invention;

FIG. 2 is a perspective view of the structure of FIG. 1 observed from the bottom of a vehicle;

FIG. 3 is an exploded view of parts comprising a suspension mounting structure of a vehicle according to an embodiment of the present invention;

FIG. 4 is a cross-sectional view of FIG. 1 along the VI-VI line;

FIG. 5 is a cross-sectional view of FIG. 1 along the V-V line; and

FIG. 6 is a perspective view illustrating a suspension module that can be mounted in as structure according to embodiments of the invention.

### DETAILED DESCRIPTION OF THE EMBODIMENTS

In the following are described preferred embodiments of this invention referring to the drawings attached.

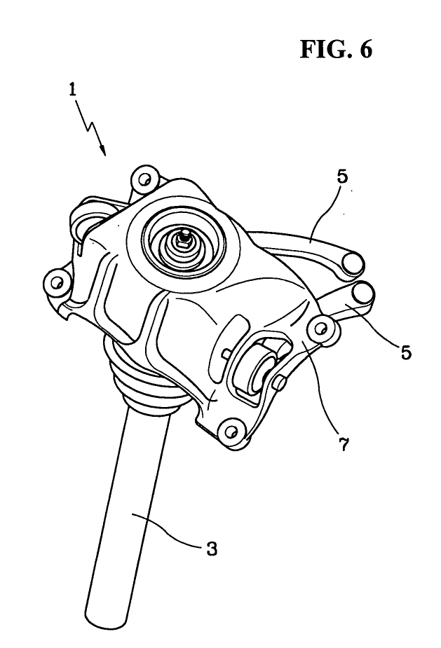

Referring to FIG. 6, a suspension module 1, for use with embodiments of the present invention, is illustrated in which shock absorbers 3 and upper arms 5 are modularized as one body. In this modularized unit, the top end of shock absorber 3 is fixed at a suspension bracket 7, and side end parts on a car body of upper arms 5 are joined with the suspension bracket 7 so as to be rotatable.

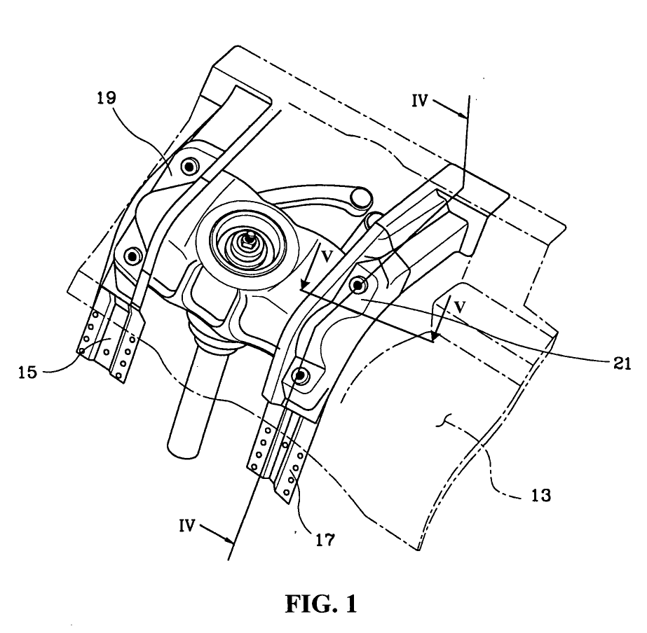

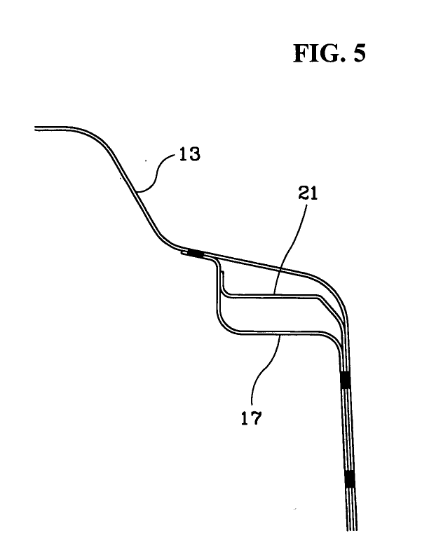

Referring to FIG. 1 to FIG. 5, a suspension mounting structure, according to embodiments of the present invention, is configured to include a shock absorber housing panel 13, wherein its top end is combined with a front apron member 9, and its bottom end is combined with a front side member 11. A front mounting rail 15 and a rear mounting rail 17 have top ends combined with the apron member 9 and bottom ends combined with a front side member 11 at the bottom of the shock absorber housing panel 13. These rails are deployed respectively in the front and rear directions of a vehicle so that a closed cross section (S) may be formed with the shock absorber housing panel 13. A front mounting bracket 19 is installed between the front mounting rail 15 and shock absorber housing panel 13 to fix weld nuts (N) with the front mounting rail 15. A rear mounting bracket 21 is installed between the rear mounting rail 17 and shock absorber housing panel 13 to fix weld nuts (N) with the rear mounting rail 17.

For the weld nuts (N) installed between the front mounting rail 15 and front mounting bracket 19, two are deployed, again one above the other, in the middle area of the front mounting rail 15. For the weld nuts (N) installed between the rear mounting rail 17 and rear mounting bracket 21, two are deployed up and down in the middle of the rear mounting rail 17. The weld nuts (N) preferably have a structure in which their center line is inclined with respect to the perpendicular direction of the vehicle. In other words, a total of 4 weld nuts (N) is used to combine one suspension module 1, and the structure is such that the center line following the spiral direction of the weld nuts (N) is inclined by approximately 45 degrees with respect to the perpendicular direction of the vehicle.

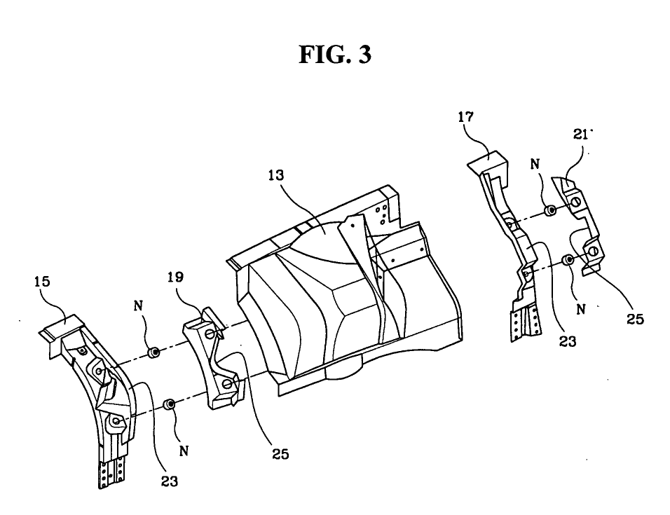

Referring to FIG. 3, it can be seen that projecting parts 23 are respectively furnished in a middle area of the front mounting rail 15 and rear mounting rail 17. These project toward the shock absorber housing panel 13. Grooves 25 are formed at the front mounting bracket 19 and the rear mounting bracket 21 that respectively receive the projecting parts 23. The projecting parts 23 prevent the area that provides support from limiting rotation of the side and of the car body at the upper arm 5 of a suspension module to avoid interference with the front mounting rail 15 and rear mounting rail 17.

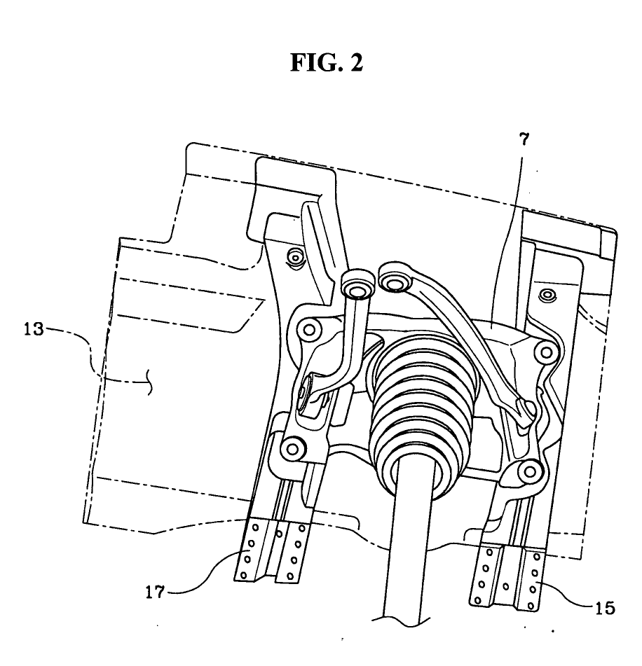

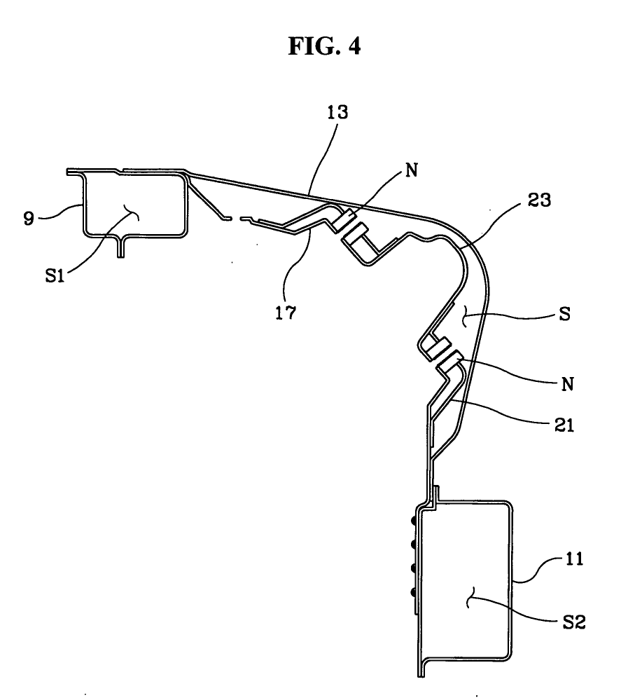

To mount a suspension module 1, the front mounting rail 15 and front mounting bracket 19 must be combined with the shock absorber housing panel 13. Weld nuts (N) are mounted, and the rear mounting rail 17 and rear mounting bracket 21 are also combined with weld nuts (N) being mounted first. The task of mounting a suspension module 1 under the condition above, as may be found from FIG. 2 and FIG. 4, is completed by joining 4 bolts with the 4 weld nuts (N) passing through the suspension bracket 7 of the suspension module 1. Therefore, the task of mounting a suspension module 1 in a car body is carried out very easily.

Referring to the FIG. 4, the closed cross section (S) formed by the rear mounting rail 17 and shock absorber housing panel 13 acts as a closed cross-section structure to connect closed cross sections (S1, S2) that are respectively formed by the front apron member 9 and front side member 1. These provide rigidity that is able to support the suspension module 1, and, as a result, generation of vehicular noise and vibration may be effectively suppressed. Of course, a closed cross section (S) is also formed between the front mounting rail 15 and shock absorber housing panel 13 that performs the action described above.

In addition, looking at the shock absorber housing panel 13 from the top of an engine room, the suspension mounting structure configured at the bottom of a shock absorber housing panel 13 is not visible so an engine room may secure a neat esthetic appearance.

According to this invention described above, a front mounting rail and a front mounting bracket are installed at the bottom of a shock absorber housing panel with weld nuts being mounted, and a rear mounting rail and a rear mounting bracket are installed with weld nuts being mounted so that a suspension module comprised by a shock absorber and an upper arm as one body may be mounted in a car body as a sturdy structure, and appearance around the suspension module mounting area looks elegant, and workability for mounting a suspension module becomes effectively simple.

1. A suspension mounting structure of a vehicle, comprising:
a shock absorber housing panel, wherein a top end is combined with a front apron member, and a bottom end is combined with a front side member;
a front mounting rail and a rear mounting rail, each having top ends combined with the apron member and bottom ends combined with a front side member at the bottom of the shock absorber housing panel, and deployed respectively in front and rear directions of the vehicle so that a closed cross section may be formed with the shock absorber housing panel;
a front mounting bracket that is installed between the front mounting rail and shock absorber housing panel to fix weld nuts with the front mounting rail; and
a rear mounting bracket that is installed between the rear mounting rail and shock absorber housing panel configured for fixing weld nuts with the rear mounting rail.

2. The suspension mounting structure of a vehicle as recited in claim 1, wherein weld nuts are installed between the front mounting rail and front mounting bracket, with two disposed in a middle area of the front mounting rail, and two disposed in a middle of the rear mounting rail.

3. The suspension mounting structure of a vehicle as recited in claim 2, wherein the weld nuts are installed with a center line inclined with respect to a perpendicular direction of the vehicle.

4. The suspension mounting structure of a vehicle as recited in claim 1, wherein projecting parts are respectively furnished in a middle area of the front mounting rail and rear mounting rail that project toward the shock absorber housing panel, and grooves are formed at the front mounting bracket and the rear mounting bracket that respectively receive the projecting parts.
